(19) United States
(12) Patent Application Publication
(10) Pub. No.: US 2004/0054781 A1
(43) Pub. Date: Mar. 18, 2004

(54) Method for establishing point to point or point to multiple points internet connection(s)

(76) Inventors: Heng-Chien Chen, Taipei (TW); Jui-Liang Weng, Kaohsiung (TW)

Correspondence Address: VENABLE, BAETJER, HOWARD AND CIVILETTI, LLP, P.O. BOX 34385, WASHINGTON, DC, 20043-9998, US

(21) Appl. No.: 10/243,670

(22) Filed: Sep. 16, 2002

(51) Int. Cl. G06F 15/16

(52) U.S. Cl. 709/227; 709/232

(57) ABSTRACT

A method for establishing a P2P Internet connection or P2MP Internet connections is applied to an IP server having multiple user's IP addresses and the network users data. Users can provide their IP address to the IP server, and the IP server provides a search IP address capability to the users to quickly locate an IP address or IP addresses. When the users obtain the IP addresses, the users can immediately establish a connection with the IP address owner. Therefore, the user can quickly and successfully establish P2P or P2MP connection(s) with distant user(s) without using a broadcast protocol.

### BACKGROUND OF THE INVENTION

1. Field of the Invention

The present invention relates to a method for establishing point to point (P2P) connections or point to multiple points (P2MP) connections on the Internet, more specifically to a method that provides a point to point (P2P) connection or point to multiple points (P2MP) connections on the Internet easily and quickly or establishing said connections without communicating with the servers that support the homepages and websites.

2. Description of Related Art

Internet is composed of many metropolis area networks (MAN) and many local area networks (LAN). The Ethernet is the main type of LAN interface that is implemented using the TCP/IP protocol. Each net device such as a personal computer, PDA, etc. connected to the Internet sends or receives data with an IP address to or from other net devices. In other words, an IP address is required to transmit data in an Ethernet network.

Users can use different connection devices to connect to the Internet, such as telephone line modems, TI, ADSL, wireless modems, cable modems, etc. Before a user uses any device to transmit data on the Internet, an IP address must first be obtained from an Internet Service Provider (ISP). In general, Ethernet devices are classified in one of two types based on transmitting speed and fees. One type includes fixed IP address devices, and the other type includes dynamic IP address devices.

A user with a fixed IP address device does not have to obtain the IP address from the ISP first. Data transmitted on the Internet is transmitted in data packages, and the data on the Internet from a user with a fixed IP address device has the fixed IP address. That is, the user's net device connected to the Internet uses the fixed IP address each time data is transmitted. Therefore, the data packages from one LAN to a distant LAN may pass through many LANs, and the individual data packages may arrive at the destination user's net device at different times. A sending user's net device has a fixed address included in the data packages so if the destination user wants to respond to the sending user, the destination user's net device uses the fixed address in the received data packages to send a response back to the sending user's net device so the response will not lost on the Internet.

With reference to FIG. 5, before the dynamic IP address user A every time uses a net device connected to the Internet, the user A first get a temporary IP address from the Internet Services Provider (ISP). Each time user A uses the net device to connect to the Internet, an IP address request is sent to a server (not shown) at the ISP. When the ISP receives the request, a temporary IP address is sent back to user A. User A uses the IP address and sends a message transmission request to the ISP, and the ISP transmits the message to a destination website. The ISP forwards the message to the destination website and establishes a virtual connection between the website and user A. Some services are set up in the website so the user A and user B can communicate with each other over the Internet. For example, the website may have a chat room or net-meeting service to provide the means for user A and user B to communicate together. Most network users do not do point to point communicates to others. Even if a user has P2P or P2MP connection capability, the temporary IP user cannot successfully establish a connection. The original user has to change to a temporary IP because the temporary IP user cannot use a fixed IP on the Internet. Therefore, a temporary IP user may send a message to distant user to establish a connection, but a response from the distant user sent to the original user cannot be received by the original user.

Although network users can communicate point to point by means of ICQ techniques, ICQ techniques us a unique broadcast protocol to search and establish links between ICQ users. However, as the number of ICQ users increases, the Internet becomes congested with the ICQ packages, which reduces the available frequency bandwidth on the Internet. Therefore, the ICQ is not suitable for a large number of point to point or point to multiple point communication links on the Internet.

Therefore, the present invention provides a means of establishing P2P or P2MP connection on the Internet that can be easily set up any place to mitigate or obviate the aforementioned problems.

### SUMMARY OF THE INVENTION

An objective of the present invention is to provide a method for establishing Internet connections. The method provides the means for network users, especially temporary IP users, to quickly and successfully establish P2P or P2MP connections on the Internet.

Other objectives, advantages and novel features of the invention will become more apparent from the following detailed description when taken in conjunction with the accompanying drawings.

### BRIEF DESCRIPTION OF THE DRAWINGS

FIG. 1 is an Internet connection diagram of a first embodiment of a method to establish Internet connections in accordance with the present invention;

FIG. 2 is a timing diagram for the method in FIG. 1.

FIG. 3 is an Internet connection diagram of a second embodiment of a method of establishing Internet connections in accordance with the present invention;

FIG. 4 is a timing diagram for the method in FIG. 3; and

FIG. 5 is an Internet connection diagram of the conventional method of establishing Internet connections.

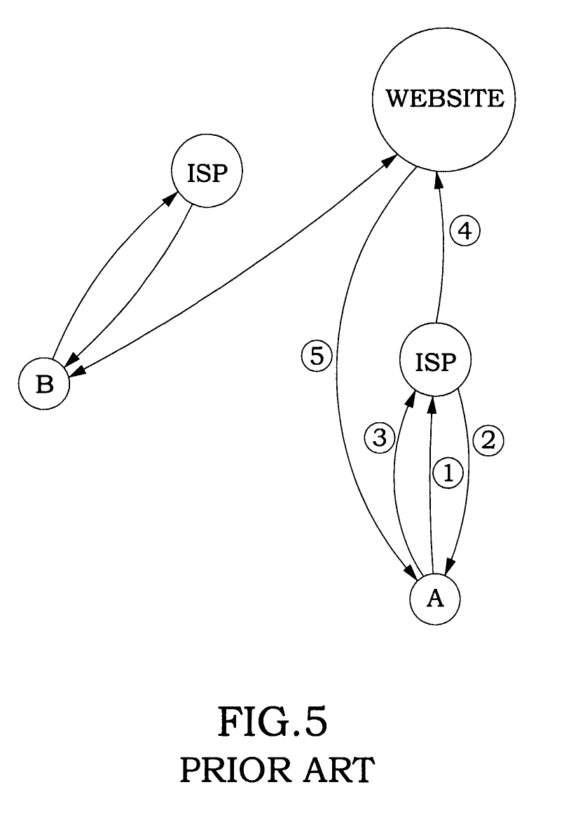

### DETAILED DESCRIPTION OF THE PREFERRED EMBODIMENT

Before a network user attempts to link to the Internet with his or her network device, the network users must first obtain an IP address. With an IP address, an establishing connection protocol is used to link to the Internet. The method for establishing point to point (P2P) or point to multiple points (P2MP) Internet connections in accordance with the present invention provides the means for users to quickly and successfully establish P2P or P2MP connections on the Internet.

At least one IP server collects IP addresses to support the method. Having multiple network users directly link to the IP server to register and provide the member information including the present IP addresses is a preferable means of collecting IP addresses. The functions performed by the IP server include:

providing an entrance to a database for network users to register member information including their present IP addresses;

maintaining the IP address database for registered network users: and

providing a database search capability for member users to locate a particular member user's IP address or the IP addresses for a number of member users. That is, when the IP server receives a search request from a member use, the search function is executed to find the desired IP address.

The method for establishing a P2P connection or P2MP Internet connections comprises the steps of

(1) linking to the IP server,

(2) searching for one IP address or multiple IP addresses,

(3) obtaining one IP address or multiple IP addresses; and

(4) establishing connections between or among users by executing the establishing connection protocol.

The linking to the IP server step is the first step for quickly establishing an Internet connection. The IP server has the IP searching function so the member user can ask the IP server to find another member user's IP address. When the user obtains the other member user's IP address, the user can immediately establish a P2P connection with the other member user by executing the establishing connection protocol step, such as the Ethernet triple handshake process using the TCP/IP protocol. Therefore, the user does not use a broadcast protocol to search for the user as is done in the ICQ technique.

Further, the searching for one IP address or multiple IP address(s) step further includes an identify member process to identify whether the user's identity matches the member's information. If the identity matches, the IP server can execute the next step.

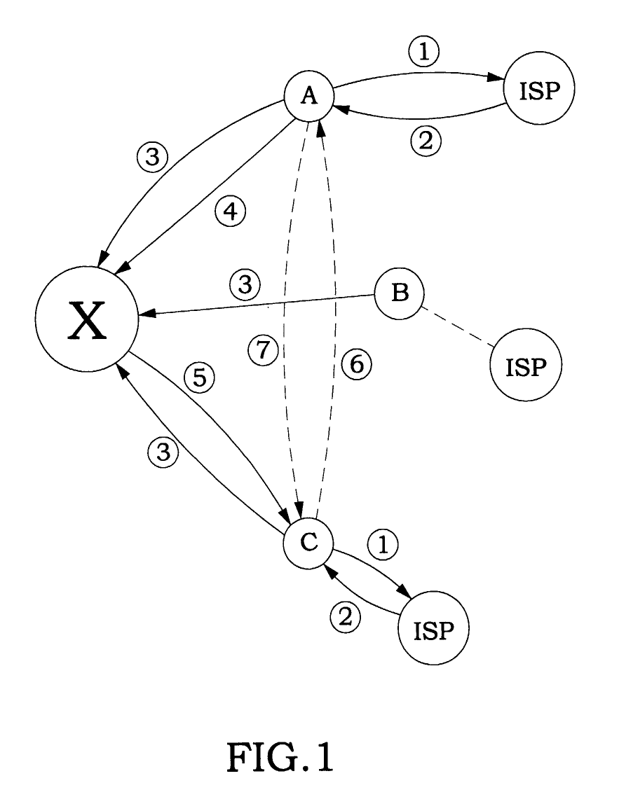

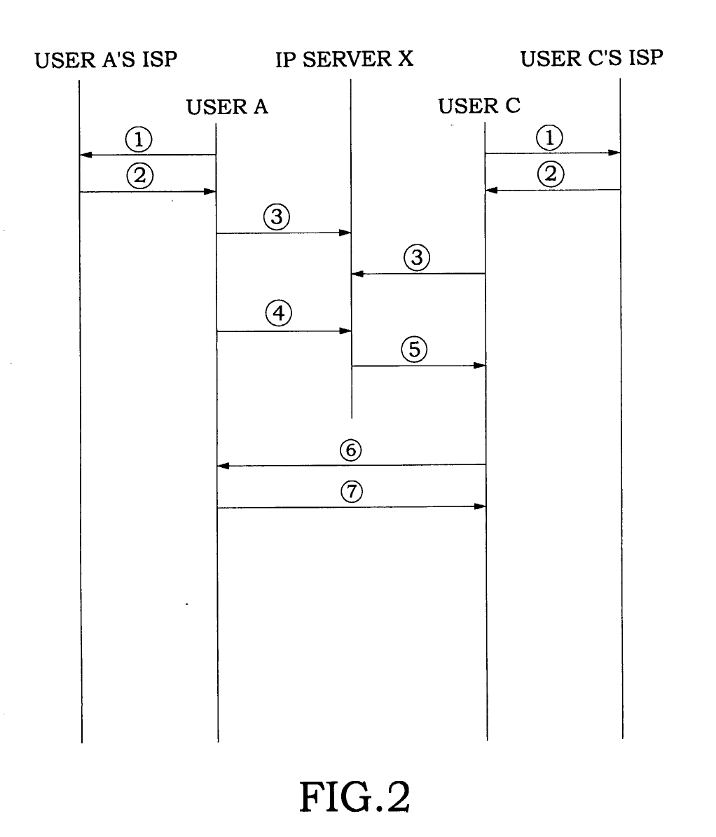

With reference to FIGS. 1 and 2, a first embodiment of the forgoing method is used to establish quickly and successfully Internet connections between or among network users. In the first embodiment of the method, user A, user B and user C must have registered previously with the IP server X as member users. If user A wants to establish a P2P connection with user C, user A first links to the IP server X to send an IP address search request message. When the IP server X receives the search request message, the search function is executed to find user A's IP address. The IP server X sends user A's IP address to user C. User C decides whether or not to respond to user A's request. If user C allows user A to establish a P2P connection, the connection process is executed between user A and user C. Therefore, the IP server X provides member's IP address searching service.

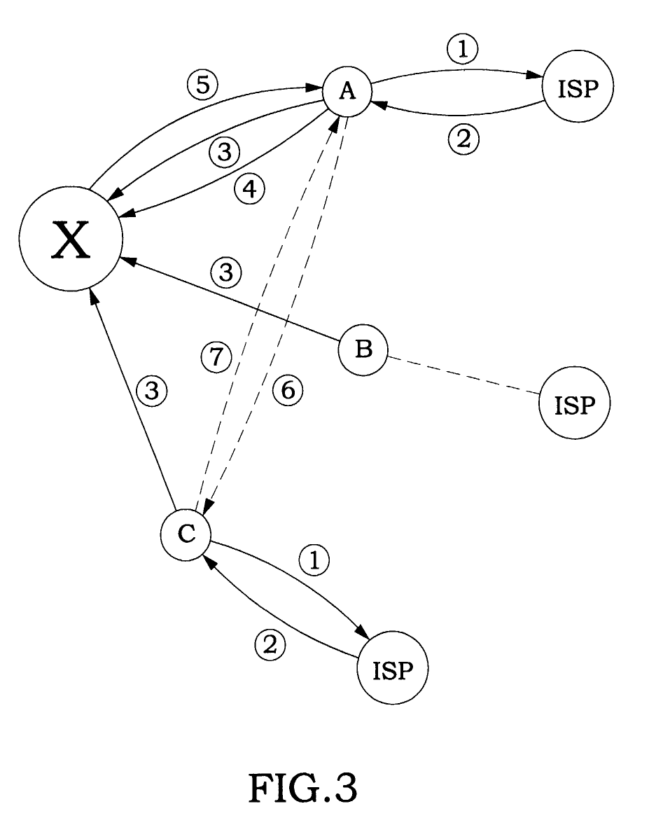

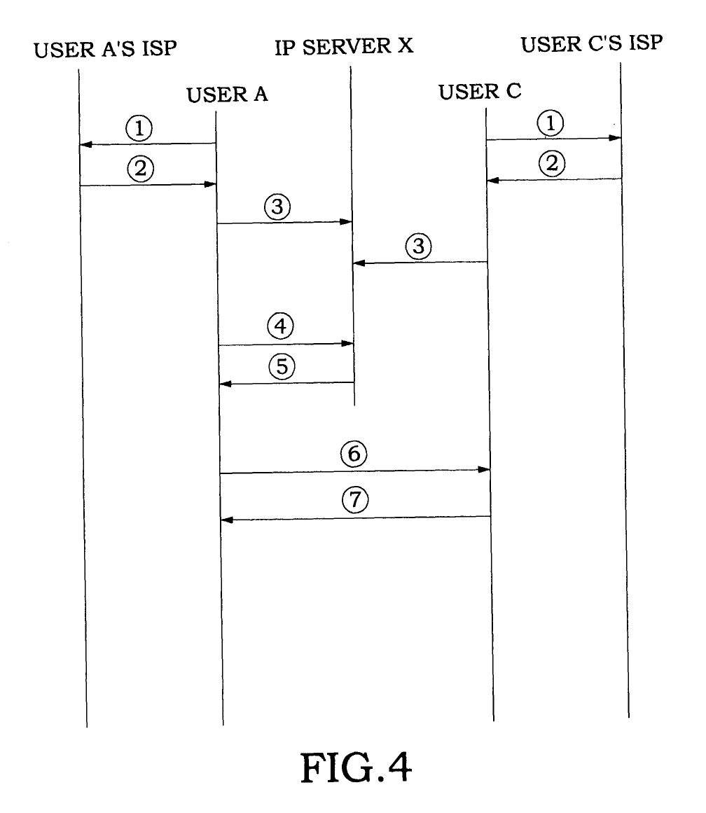

With reference to FIGS. 3 and 4, a second preferred embodiment of the present method is similar to the first embodiment. However, when the IP server X finds user C's IP address, the IP server X directly sends user C's IP address to user A. Therefore, the IP server X further has a controlling IP address sending function. Therefore, after user A obtains user C's IP address, user A can immediately sends an establishing P2P connection request message to user C. The connection request message is formed in IP packages with user A's IP address and user C's IP address. Therefore the IP packages can be successfully sent to the user C. When user C receives all the IP packages from user A, user C obtains user A's IP address to complete establishing the P2P connection to communicate with user A.

The first and the second embodiments are examples of a P2P connection. However, the method for establishing a P2MP connection is the same as the method for the P2P connection, only the IP server X has to search for multiple users' IP addresses after receiving the search request message.

Based on the description, the method for establishing P2P or P2MP connections can provide network users with a quick means of searching for an IP address or addresses to establish a connection with the IP address owner or owners. Therefore, the network user with a temporary IP address from the ISP can easily search for the other user's IP address. Once the connection is established, the temporary IP user still can communicate with the other user even when the temporary IP address is changed by the ISP during the communication. Therefore, no matter what kind of IP addresses the users use, the method provides the users quick and successful the Internet connection without having to go through servers supported homepage and website.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for establishing point to point (P2P) or point to multiple points (P2MP) Internet connections, comprising:
(1) linking to an IP server which collects multiple network users' information including IP addresses and the network users data;
(2) searching for one IP address or multiple IP addresses in the IP server, wherein one source network user sends an IP search request message, which includes destination network user's or users' information without his/her or their IP address or addresses, to the IP server to find the destination network user's IP address or users' IP addresses;
(3) obtaining one IP address or multiple IP addresses from the IP server, wherein the IP server sends the source user's IP address to each destination network user; and
(4) establishing the P2P or P2MP Internet connection(s) by an establishing connection protocol, wherein each destination network user obtains the source user's IP address to execute the establishing connection protocol to establish a connection with the source network user.

2. The method as claimed in claim 1, wherein functions performed by the IP server comprise:
providing an entrance to a database for network users to register member information including their own present IP addresses;
maintaining the IP address database for registered network users; and
providing a database search capability for the network users to locate a particular member user's IP address or the IP addresses of a number of member users.

3. The method as claimed in claim 1, further comprises an identify member process in the obtaining one IP address or multiple IP addresses step to identify whether the user's identity matches the member's information.

4. The method as claimed in claim 1, where the network user uses a temporary IP address.

5. The method as claimed in claim 4, where the establishing connection protocol is a handshake connection process.

6. A method for establishing point to point (P2P) or point to multiple points (P2MP) Internet connection, comprising:
(1) linking to an IP server that has collected multiple network users' information including IP addresses and the network users own data;
(2) searching for one IP address or multiple IP addresses in the IP server, wherein a source network user sends an IP search request message, which includes destination network user's or users' information without his/her IP address or their IP addresses, to the IP server to find the destination network user's IP address or the destination network users' IP addresses;
(3) obtaining one IP address or multiple IP addresses from the IP server, wherein the IP server sends the destination network user's or users' IP address(es) founded from the above step to the source network user who sends the IP search request message; and
(4) establishing the P2P or P2MP Internet connection(s) by an establishing connection protocol, wherein the source network user obtains the IP address(es) to execute the establishing connection protocol to establish connection(s) with each destination network user(s).

7. The method as claimed in claim 6, wherein the functions performed by IP server comprise:
providing an entrance to a database for network users to register member information including their own present IP addresses;
maintaining the IP address database for registered network users; and
providing a database search capability for the network users to locate a particular member user's IP address or the IP addresses of a number of member users.

8. The method as claimed in claim 6, further comprises an identify member process in the obtaining one IP address or multiple IP addresses step to identify whether the user's identity matches the member's information.

9. The method as claimed in claim 6, where the network user uses a temporary IP address.

10. The method as claimed in claim 9, where the establishing connection protocol is handshake connection process.
